(19) United States
(12) Patent Application Publication
(10) Pub. No.: US 2016/0060430 A1
(43) Pub. Date: Mar. 3, 2016

(54) Polyolefin Compositions And Processes For Making The Same

(71) Applicant: ExxonMobil Chemical Company - Law Technology, Baytown, TX (US)

(72) Inventor: Jozef A. F. Smits, Aartselaar (BE)

(21) Appl. No.: 14/934,918

(22) Filed: Nov. 6, 2015

(51) Int. Cl. C08K 5/524; C09D 123/04; C08J 5/18; C08K 5/134

(52) U.S. Cl. CPC C08K 5/524; C08K 5/1345; C09D 123/04; C08J 5/18

(57) ABSTRACT

Polyolefin compositions including phosphite additives and methods for making the same are provided.

### FIELD OF THE INVENTION

The present invention generally relates to polyolefin compositions made from polyolefin polymers, such as ethylene-based polymers and/or propylene-based polymers, and certain phosphite additives.

### BACKGROUND OF THE INVENTION

Additives and/or one or more neutralizing agents are commonly used with polyolefin materials to impart various properties to polymeric materials to make them more suitable for their transport, storage, and intended use. However, the addition of such additives may also have a negative impact on certain other properties.

For example, the addition of certain antioxidants or neutralizing agents may cause plate out and/or blooming. The term “plate(ing) out” as used herein, refers to the disposition of one or more residues, e.g. phosphite and oxidized phosphite residues, or residue mass derived from octadecyl-3-(3,5-di-tert.butyl-4-hydroxyphenyl)-propionate, or an acid derivative of one or more neutralizing agents, such calcium stearate or zinc stearate, or residue mass, such as stearic acid residue mass, from one or more additive materials from a molten polymer, may accumulate onto one or more surfaces of one or more pieces of equipment during the fabrication of films and/or articles made from such polyolefin materials. The term “bloom(ing)” refers to the migration of one or more residues, e.g. phosphite and oxidized phosphite residues, or residue mass derived from pentaerythritol tetrakis(3-(3,5-di-tert-butyl-4-hydroxyphenyl)propionate), from one or more additive materials to the exterior surface of a film and/or fabricated article.

As a result, the production lines may be required to shutdown to take appropriate measures to remove accumulated residual deposits from the surface of equipment. Such continuous maintenance creates additional undesired cost; thus, it is desired to minimize plate outs and bloomings. See, for example, US 2013/0225738.

One particular category of additives that is prone to blooming are phosphites, used as secondary antioxidants to protect the polymer during processing. Typical examples of this additive type are: tris(2,4-ditert-butylphenyl)phosphite (CAS #31570-04-4 (e.g., Irgafos 168)), bis(2,4-di-tert-butylphenyl)pentaerythritol diphosphite (CAS #26741-53-7 (e.g., Ultranox 626)), phosphorous trichloride, reaction products with 1,1′-biphenyl and 2,4-bis(1,1-dimethylethyl) phenol (CAS #119345-01-6 (e.g., Hostanox PEPQ)) and bis(2,4-dicumylphenyl)pentaerythritol (CAS #154862-43-8 (e.g., Doverphos 9228)). At the high concentrations needed to protect polyolefins in demanding conversion processes, the product can bloom to the surface of the pellets or the converted articles. This creates streamers in the pellets, surface defects and/or deposits on the converting equipment.

Tris Nonylphenol Phosphite (TNPP) is a liquid phosphites that does not exhibit the same blooming behavior. It is therefore the preferred phosphite for polyolefins requiring high conversion stability. However it generates nonylphenol upon hydrolyzation which is subject to restrictions and some cases prohibitions in certain jurisdictions.

Thus, there is a need to have antioxidants suitable for polyolefin applications that are TNPP free that satisfy market demand and regulatory schemes around the world.

### SUMMARY OF THE INVENTION

In a class of embodiments of the invention, the invention provides for a composition comprising: a) at least one polyolefin polymer, b) from 100 to 4000 parts by weight of a first antioxidant, and c) from 1 to 450 parts by weight of a second antioxidant, based on one million parts of the polyolefin polymer.

In another class of embodiments, the invention also provides for a process to produce a composition comprising contacting: a) at least one polyolefin polymer, b) from 100 to 2000 parts by weight of a first antioxidant, and c) from 1 to 2500 parts by weight of a second antioxidant, based on one million parts of the polyolefin polymer, preferably, the second antioxidant being a phosphite which is liquid at room temperature.

In several classes of embodiments of the invention, an advantage is that the new system has significantly less low molecular weight components compared to existing commercial systems which use TNPP. Low molecular weight components can be produced through hydrolyzation and do not contribute to the stabilization process. They can generate volatile matter escaping the polymer during processing. Additionally, they can be of an environmental concern, like in the case of nonylphenol. Thus, embodiments of the invention cover a way to make stabilized polyolefins with significantly less low molecular weight components.

Other embodiments of the invention are described and claimed herein and are apparent by the following disclosure.

### DETAILED DESCRIPTION OF ILLUSTRATIVE EMBODIMENTS

Before the present polymers, compounds, components, compositions, and/or methods are disclosed and described, it is to be understood that unless otherwise indicated this invention is not limited to specific polymers, compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

It must also be noted that, as used in the specification and the appended claims, the singular forms “a,” “an” and “the” include plural referents unless otherwise specified.

### DEFINITIONS

For the purposes of this disclosure, the following definitions will apply, unless otherwise stated:

Molecular weight distribution (“MWD”) is equivalent to the expression M_{w}/Mₙ. The expression M_{w}/Mₙ is the ratio of the weight average molecular weight (M_{w}) to the number average molecular weight (Mₙ). The weight average molecular weight is given by

$${M}_{w} = \frac{{\sum }_{i} {n}_{i} {M}_{i}^{2}}{{\sum }_{i} {n}_{i} {M}_{i}}$$

The number average molecular weight is given by

$${M}_{n} = \frac{{\sum }_{i} {n}_{i} {M}_{i}}{{\sum }_{i} {n}_{i}}$$

The z-average molecular weight is given by

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of M_{w}, M_{z}, and Mₙ are typically determined by Gel Permeation Chromatography as disclosed in Macromolecules, Vol. 34, No. 19, pg. 6812 (2001). This method is the preferred method of measurement and used in the examples and throughout the disclosures unless otherwise specified.

The broadness of the composition distribution of the polymer may be characterized by T₇₅−T₂₅. It is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., Vol. 20, pg. 441 (1982) and U.S. Pat. No. 5,008,204. For example, TREF may be measured using an analytical size TREF instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min. Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm⁻¹ using an infrared detector. The concentration of the ethylene-α-olefin copolymer in the eluted liquid may be calculated from the absorption and plotted as a function of temperature. As used herein, T₇₅−T₂₅ values refer to where T₂₅ is the temperature in degrees Celsius at which 25% of the eluted polymer is obtained and T₇₅ is the temperature in degrees Celsius at which 75% of the eluted polymer is obtained via a TREF analysis. For example, in an embodiment, a polyolefin polymer may have a T₇₅−T₂₅ value from 5 to 10, alternatively, a T₇₅−T₂₅ value from 5.5 to 10, and alternatively, a T₇₅−T₂₅ value from 5.5 to 8, alternatively, a T₇₅−T₂₅ value from 6 to 10, and alternatively, a T₇₅−T₂₅ value from 6 to 8, where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF).

In another class of embodiments, T₇₅−T₂₅ may be defined by the formula T₇₅−T₂₅=117.41+28.1*MI-122.5*density−29.3*MI*density with a given MI and density.

Additional definitions that will better help the reader understand the claimed invention are provided below.

### Polyolefin Polymers

### First Polyethylene Polymer

The first polyethylene polymer includes ethylene-based polymers having about 99.0 to about 80.0 wt %, 99.0 to 85.0 wt %, 99.0 to 87.5 wt %, 99.0 to 90.0 wt %, 99.0 to 92.5 wt %, 99.0 to 95.0 wt %, or 99.0 to 97.0 wt %, of polymer units derived from ethylene and about 1.0 to about 20.0 wt %, 1.0 to 15.0 wt %, 1.0 to 12.5 wt %, 1.0 to 10.0 wt %, 1.0 to 7.5 wt %, 1.0 to 5.0 wt %, or 1.0 to 3.0 wt % of polymer units derived from one or more C₃ to C₂₀ α-olefin comonomers, preferably C₃ to C₁₀ α-olefins, and more preferably C₄ to C₈ α-olefins. The α-olefin comonomer may be linear, branched, cyclic and/or substituted, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

In an embodiment of the invention, the polymer comprises from about 8 wt % to about 15 wt %, of C₃-C₁₀ α-olefin derived units, and from about 92 wt % to about 85 wt % ethylene derived units, based upon the total weight of the polymer.

In another embodiment of the invention, the polymer comprises from about 9 wt % to about 12 wt %, of C₃-C₁₀ α-olefin derived units, and from about 91 wt % to about 88 wt % ethylene derived units, based upon the total weight of the polymer.

The first polyethylene polymer may have a melt index (MI), I_{2.16} or simply I₂ for shorthand according to ASTM D1238, condition E (190° C./2.16 kg) reported in grams per 10 minutes (g/10 min), of ≧about 0.10 g/10 min., e.g., ≧about 0.15 g/10 min., ≧about 0.18 g/10 min., ≧about 0.20 g/10 min., ≧about 0.22 g/10 min., ≧about 0.25 g/10 min., or ≧about 0.28 g/10 min. Additionally, the first polyethylene polymer may have a melt index (I_{2.16}) ≦about 3.0 g/10 min., e.g., ≦about 2.0 g/10 min., ≦about 1.0 g/10 min., ≦about 0.70 g/10 min., ≦about 0.50 g/10 min., ≦about 0.30 g/10 min., ≦about 0.25 g/10 min., ≦about 0.22 g/10 min., ≦about 0.20 g/10 min., ≦about 0.18 g/10 min., or ≦about 0.15 g/10 min. Ranges expressly disclosed include, but are not limited to, ranges formed by combinations any of the above-enumerated values, e.g., from about 0.1 to about 3.0, about 0.2 to about 2.0, about 0.2 to about 1.0 g/10 min., etc.

The first polyethylene polymer may also have High Load Melt Index (HLMI), I_{21.6} or I₂₁ for shorthand, measured in accordance with ASTM D-1238, condition F (190° C./21.6 kg). For a given polymer having an MI and MIR as defined herein the HLMI is fixed and can be calculated in accordance with the following paragraph.

The polyethylene polymers may have a Melt Index Ratio (MIR) which is a dimensionless number and is the ratio of the high load melt index to the melt index, or I_{21.6}/I_{2.16} as described above. The MIR of the polyethylene polymers may be from 25 to 80, alternatively, from 25 to 60, alternatively, from about 30 to about 55, and alternatively, from about 35 to about 50.

The first polyethylene polymer may have a density ≧about 0.905 g/cm³, ≧about 0.910 g/cm³, ≧about 0.912 g/cm³, ≧about 0.913 g/cm³, ≧about 0.915 g/cm³, ≧about 0.916 g/cm³, ≧about 0.917 g/cm³, ≧about 0.918 g/cm³. Additionally or alternatively, the first polyethylene polymer may have a density ≦about 0.945 g/cm³, e.g., ≦about 0.940 g/cm³, ≦about 0.937 g/cm³, ≦about 0.930 g/cm³, ≦about 0.915 g/cm³, or ≦about 0.914 g/cm³. Ranges expressly disclosed include, but are not limited to, ranges formed by combinations any of the above-enumerated values, e.g., from about 0.905 to about 0.945 g/cm³, 0.910 to about 0.940 g/cm³, 0.915 to 0.930 g/cm³, 0.914 to 0.920 g/cm³, 0.915 to 0.917 g/cm³, etc. Density is determined using chips cut from plaques compression molded in accordance with ASTM D-1928 Procedure C, aged in accordance with ASTM D-618 Procedure A, and measured as specified by ASTM D-1505.

Typically, although not necessarily, the first polyethylene polymer may have a molecular weight distribution (MWD, defined as M_{w}/Mₙ) of about 2.5 to about 5.5, preferably 4.0 to 5.0.

The melt strength of a polymer at a particular temperature may be determined with a Gottfert Rheotens Melt Strength Apparatus. To determine the melt strength, a polymer melt strand extruded from the capillary die is gripped between two counter-rotating wheels on the apparatus. The take-up speed is increased at a constant acceleration of 2.4 mm/sec². The maximum pulling force (in the unit of cN) achieved before the strand breaks or starts to show draw-resonance is determined as the melt strength. The temperature of the rheometer is set at 190° C. The capillary die has a length of 30 mm and a diameter of 2 mm. The polymer melt is extruded from the die at a speed of 10 mm/sec. The distance between the die exit and the wheel contact point should be 122 mm. The melt strength of the first polyethylene may be in the range from about 1 to about 100 cN, about 1 to about 50 cN, about 1 to about 25 cN, about 3 to about 15 cN, about 4 to about 12 cN, or about 5 to about 10 cN.

The first polyethylene polymer (or films made therefrom) may also be characterized by an averaged 1% secant modulus (M) of from 10,000 to 60,000 psi (pounds per square inch), alternatively, from 20,000 to 40,000 psi, alternatively, from 20,000 to 35,000 psi, alternatively, from 25,000 to 35,000 psi, and alternatively, from 28,000 to 33,000 psi, and a relation between M and the dart drop impact strength in g/mil (DIS) complying with formula (A):

DIS≧0.8*[100+e^{-(11.71-0.000268M+2.183×10}^{^{−9}}^{M}^{²}⁾], (A)

where “e” represents 2.7183, the base Napierian logarithm, M is the averaged modulus in psi, and DIS is the 26 inch dart impact strength. The DIS is preferably from about 120 to about 1000 g/mil, even more preferably, from about 150 to about 800 g/mil.

The relationship of the Dart Impact Strength to the averaged 1% secant modulus is thought to be one indicator of long-chain branching in the ethylene-based polymer. Thus, alternatively ethylene-based polymers of certain embodiments may be characterized as having long-chain branches. Long-chain branches for the purposes of this invention represent the branches formed by reincorporation of vinyl-terminated macromers, not the branches formed by incorporation of the comonomers. The number of carbon atoms on the long-chain branches ranges from a chain length of at least one carbon more than two carbons less than the total number of carbons in the comonomer to several thousands. For example, a long-chain branch of an ethylene/hexene ethylene-based polymer may have chain comprising greater than 6 carbon atoms, greater than 8 carbon atoms, greater than 10 carbon atoms, greater than 12 carbon atoms, etc. and combinations thereof for long-chain branches.

Various methods are known for determining the presence of long-chain branches. For example, long-chain branching may be determined using ¹³C nuclear magnetic resonance (NMR) spectroscopy and to a limited extent; e.g., for ethylene homopolymers and for certain copolymers, and it can be quantified using the method of Randall (Journal of Macromolecular Science, Rev. Macromol. Chem. Phys., C29 (2&3), p. 285-297). Although conventional ¹³C NMR spectroscopy cannot determine the length of a long-chain branch in excess of about six carbon atoms, there are other known techniques useful for quantifying or determining the presence of long-chain branches in ethylene-based polymers, such as ethylene/1-octene interpolymers. For those ethylene-based polymers wherein the ¹³C resonances of the comonomer overlap completely with the ¹³C resonances of the long-chain branches, either the comonomer or the other monomers (such as ethylene) can be isotopically labeled so that the long-chain branches can be distinguished from the comonomer. For example, a copolymer of ethylene and 1-octene can be prepared using ¹³C-labeled ethylene. In this case, the resonances associated with macromer incorporation will be significantly enhanced in intensity and will show coupling to neighboring ¹³C carbons, whereas the octene resonances will be unenhanced.

Alternatively, the degree of long-chain branching in ethylene-based polymers may be quantified by determination of the branching index. The branching index g′ is defined by the following equation:

$${g}^{′} = \begin{matrix}{IV}_{Br} \\ {IV}_{Lin}\end{matrix} {\vert}_{Mw}$$

where g′ is the branching index, IV_{Br} is the intrinsic viscosity of the branched ethylene-based polymer and IV_{Lin} is the intrinsic viscosity of the corresponding linear ethylene-based polymer having the same weight average molecular weight and molecular weight distribution as the branched ethylene-based polymer, and in the case of copolymers and terpolymers, substantially the same relative molecular proportion or proportions of monomer units. For the purposes, the molecular weight and molecular weight distribution are considered “the same” if the respective values for the branched polymer and the corresponding linear polymer are within 10% of each other. Preferably, the molecular weights are the same and the MWD of the polymers are within 10% of each other. A method for determining intrinsic viscosity of polyethylene is described in Macromolecules, 2000, 33, 7489-7499. Intrinsic viscosity may be determined by dissolving the linear and branched polymers in an appropriate solvent, e.g., trichlorobenzene, typically measured at 135° C. Another method for measuring the intrinsic viscosity of a polymer is ASTM D-5225-98—Standard Test Method for Measuring Solution Viscosity of Polymers with a Differential Viscometer, which is incorporated by reference herein in its entirety. This method is the preferred method of measurement and relates to any branching value(s) described herein, including the examples and claims, unless otherwise specified.

The branching index, g′ is inversely proportional to the amount of branching. Thus, lower values for g′ indicate relatively higher amounts of branching. The amounts of short and long-chain branching each contribute to the branching index according to the formula: g′=g′_{LCB}×g′_{SCB}. Thus, the branching index due to long-chain branching may be calculated from the experimentally determined value for g′ as described by Scholte, et al., in J. App. Polymer Sci., 29, pp. 3763-3782 (1984), incorporated herein by reference.

Typically, the first polyethylene polymer may have a g′vis of 0.85 to 0.99, particularly, 0.87 to 0.97, 0.89 to 0.97, 0.91 to 0.97, 0.93 to 0.95, or 0.97 to 0.99.

The first polyethylene polymer may be made by any suitable polymerization method including solution polymerization, slurry polymerization, gas phase polymerization using supported or unsupported catalyst systems, such as a system incorporating a metallocene catalyst.

As used herein, the term “metallocene catalyst” is defined to comprise at least one transition metal compound containing one or more substituted or unsubstituted cyclopentadienyl moiety (Cp) (typically two Cp moieties) in combination with a Group 4, 5, or 6 transition metal, such as, zirconium, hafnium, and titanium.

Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system may be supported on a carrier, typically an inorganic oxide or chloride or a resinous material such as, for example, polyethylene or silica.

Zirconium transition metal metallocene-type catalyst systems are particularly suitable. Non-limiting examples of metallocene catalysts and catalyst systems useful in practicing the present invention include those described in, U.S. Pat. Nos. 5,466,649, 6,476,171, 6,225,426, and 7,951,873; and in the references cited therein, all of which are fully incorporated herein by reference. Particularly useful catalyst systems include supported dimethylsilyl bis(tetrahydroindenyl) zirconium dichloride.

Supported polymerization catalyst may be deposited on, bonded to, contacted with, or incorporated within, adsorbed or absorbed in, or on, a support or carrier. In another embodiment, the metallocene is introduced onto a support by slurrying a presupported activator in oil, a hydrocarbon such as pentane, solvent, or non-solvent, then adding the metallocene as a solid while stirring. The metallocene may be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane may be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor. (See e.g., U.S. Pat. Nos. 4,543,399; 4,588,790; 5,028,670; 5,317,036; 5,352,749; 5,405,922; 5,436,304; 5,453,471; 5,462,999; 5,616,661; and 5,668,228 all of which are fully incorporated herein by reference.)

Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. The reactor pressure may vary from 100 psig (680 kPag)-500 psig (3448 kPag), or in the range of from 200 psig (1379 kPag)-400 psig (2759 kPag), or in the range of from 250 psig (1724 kPag)-350 psig (2414 kPag). The reactor may be operated at a temperature in the range of 60° C. to 120° C., 60° C. to 115° C., 70° C. to 110° C., 75° C. to 95° C., or 80° C. to 95° C. The productivity of the catalyst or catalyst system is influenced by the main monomer partial pressure. The mole percent of the main monomer, ethylene, may be from 25.0-90.0 mole percent, or 50.0-90.0 mole percent, or 70.0-85.0 mole percent, and the monomer partial pressure may be in the range of from 75 psia (517 kPa)-300 psia (2069 kPa), or 100-275 psia (689-1894 kPa), or 150-265 psia (1034-1826 kPa), or 200-250 psia (1378-1722 kPa).

To obtain the inventive polymers and films made therefrom, individual flow rates of ethylene, comonomer, and hydrogen should be controlled to produce the desired ethylene-based polymer as recognized in the art.

Other gas phase processes contemplated by the process of the invention include those described in U.S. Pat. Nos. 5,627,242, 5,665,818 and 5,677,375, 6,255,426 and European published patent applications EP-A-0 794 200, EP-A-0 802 202, and EP-B-0 634 421 all of which are herein fully incorporated by reference.

Additionally, the use of a process continuity aid, while not required, may be desirable in any of the foregoing processes. Such continuity aids are well known to persons of skill in the art and include, for example, metal stearates.

Suitable commercial polymers for the first polyethylene polymer are available from ExxonMobil Chemical Company as Enable™ metallocene polyethylene (mPE) resins.

### Second Polyethylene Polymer

The second polyethylene polymer includes ethylene-based polymers comprising ≧50.0 wt % of polymer units derived from ethylene and ≦50.0 wt % preferably 1.0 wt % to 35.0 wt %, even more preferably 1 to 6 wt % of polymer units derived from a C₃ to C₂₀ alpha-olefin comonomer (for example, hexene or octene).

The second polyethylene polymer may have a density of ≧about 0.910 g/cm³, ≧about 0.915 g/cm³, ≧about 0.920 g/cm³, ≧about 0.925 g/cm³, ≧about 0.930 g/cm³, or ≧about 0.940 g/cm³. Alternatively, the second polyethylene polymer may have a density of ≦about 0.950 g/cm³, e.g., ≦about 0.940 g/cm³, ≦about 0.930 g/cm³, ≦about 0.925 g/cm³, ≦about 0.920 g/cm³, or ≦about 0.915 g/cm³. Ranges expressly disclosed include ranges formed by combinations any of the above-enumerated values, e.g., 0.910 to 0.950 g/cm³, 0.910 to 0.930 g/cm³, 0.910 to 0.925 g/cm³, etc. Density is determined using chips cut from plaques compression molded in accordance with ASTM D-1928 Procedure C, aged in accordance with ASTM D-618 Procedure A, and measured as specified by ASTM D-1505.

The second polyethylene polymer may have a melt index (I₂₁₆) according to ASTM D1238 (190° C./2.16 kg) of ≧about 0.5 g/10 min., e.g., ≧about 0.5 g/10 min., ≧about 0.7 g/10 min., ≧about 0.9 g/10 min., ≧about 1.1 g/10 min., ≧about 1.3 g/10 min., ≧about 1.5 g/10 min., or ≧about 1.8 g/10 min. Alternatively, the melt index (I₂₁₆) may be ≦about 8.0 g/10 min., ≦about 7.5 g/10 min., ≦about 5.0 g/10 min., ≦about 4.5 g/10 min., ≦about 3.5 g/10 min., ≦about 3.0 g/10 min., ≦about 2.0 g/10 min., e.g., ≦about 1.8 g/10 min., ≦about 1.5 g/10 min., ≦about 1.3 g/10 min., ≦about 1.1 g/10 min., ≦about 0.9 g/10 min., or ≦about 0.7 g/10 min., 0.5 to 2.0 g/10 min., particularly 0.75 to 1.5 g/10 min. Ranges expressly disclosed include ranges formed by combinations any of the above-enumerated values, e.g., about 0.5 to about 8.0 g/10 min., about 0.7 to about 1.8 g/10 min., about 0.9 to about 1.5 g/10 min., about 0.9 to 1.3, about 0.9 to 1.1 g/10 min., about 1.0 g/10 min., etc.

In particular embodiments, the second polyethylene polymer may have a density of 0.910 to 0.920 g/cm³, a melt index (I₂₁₆) of 0.5 to 8.0 g/10 min., and a CDBI of 60.0% to 80.0%, preferably between 65% and 80%.

The second polyethylene polymers are generally considered linear. Suitable second polyethylene polymers are available from ExxonMobil Chemical Company under the trade name Exceed™ metallocene (mPE) resins. The MIR for Exceed materials will typically be from about 15 to about 20.

### Third Polyethylene Polymer

The third polyethylene polymer may be a polyethylene homopolymer or a copolymer of ethylene and one or more polar comonomers and/or C₃ to C₁₀ α-olefins. Typically, the third polyethylene polymer includes 99.0 to about 80.0 wt %, 99.0 to 85.0 wt %, 99.0 to 87.5 wt %, 95.0 to 90.0 wt %, of polymer units derived from ethylene and about 1.0 to about 20.0 wt %, 1.0 to 15.0 wt %, 1.0 to 12.5 wt %, or 5.0 to 10.0 wt % of polymer units derived from one or more polar comonomers, based upon the total weight of the polymer. Suitable polar comonomers include, but are not limited to: vinyl ethers such as vinyl methyl ether, vinyl n-butyl ether, vinyl phenyl ether, vinyl beta-hydroxy-ethyl ether, and vinyl dimethylamino-ethyl ether; olefins such as propylene, butene-1, cis-butene-2, trans-butene-2, isobutylene, 3,3,-dimethylbutene-1, 4-methylpentene-1, octene-1, and styrene; vinyl type esters such as vinyl acetate, vinyl butyrate, vinyl pivalate, and vinylene carbonate; haloolefins such as vinyl fluoride, vinylidene fluoride, tetrafluoroethylene, vinyl chloride, vinylidene chloride, tetrachloroethylene, and chlorotrifluoroethylene; acrylic-type esters such as methyl acrylate, ethyl acrylate, n-butyl acrylate, t-butyl acrylate, 2-ethylhexyl acrylate, alpha-cyanoisopropyl acrylate, beta-cyanoethyl acrylate, o-(3-phenylpropan-1,3,-dionyl)phenyl acrylate, methyl methacrylate, n-butyl methacrylate, t-butyl methacrylate, cyclohexyl methacrylate, 2-ethylhexyl methacrylate, methyl methacrylate, glycidyl methacrylate, beta-hydroxethyl methacrylate, beta-hydroxpropyl methacrylate, 3-hydroxy-4-carbo-methoxy-phenyl methacrylate, N,N-dimethylaminoethyl methacrylate, t-butylaminoethyl methacrylate, 2-(1-aziridinyl)ethyl methacrylate, diethyl fumarate, diethyl maleate, and methyl crotonate; other acrylic-type derivatives such as acrylic acid, methacrylic acid, crotonic acid, maleic acid, methyl hydroxy maleate, itaconic acid, acrylonitrile, fumaronitrile, N,N-dimethylacrylamide, N-isopropylacrylamide, N-t-butylacrylamide, N-phenylacrylamide, diacetone acrylamide, methacrylamide, N-phenylmethacrylamide, N-ethylmaleimide, and maleic anhydride; and other compounds such as allyl alcohol, vinyltrimethylsilane, vinyltriethoxysilane, N-vinylcarbazole, N-vinyl-N-methylacetamide, vinyldibutylphosphine oxide, vinyldiphenylphosphine oxide, bis-(2-chloroethyl) vinylphosphonate, and vinyl methyl sulfide.

In some embodiments, the third polyethylene polymer is an ethylene/vinyl acetate copolymer having about 2.0 wt % to about 15.0 wt %, typically about 5.0 wt % to about 10.0 wt %, polymer units derived from vinyl acetate, based on the amounts of polymer units derived from ethylene and vinyl acetate (EVA). In certain embodiments, the EVA resin can further include polymer units derived from one or more comonomer units selected from propylene, butene, 1-hexene, 1-octene, and/or one or more dienes.

Suitable dienes include, for example, 1,4-hexadiene, 1,6-octadiene, 5-methyl-1,4-hexadiene, 3,7-dimethyl-1,6-octadiene, dicyclopentadiene (DCPD), ethylidene norbornene (ENB), norbornadiene, 5-vinyl-2-norbornene (VNB), and combinations thereof.

The third polyethylene polymers are available from ExxonMobil Chemical Company as ExxonMobil™ Low Density Polyethylene (LDPE) or Nexxstar™ resins.

Additional polyethylene polymers such as ExxonMobil™ High Density Polyethylene (HDPE) (available from ExxonMobil Chemical Company, Houston, Tex.) are also contemplated as ethylene-based polymers for use in embodiments of the invention. The HDPE may be a unimodal or bimodal/multimodal homopolymer or copolymer and have a narrow molecular weight distribution (MWD) or broad MWD.

Low Density polyethylene homopolymers and copolymers made with the High Pressure Polyethylene Process (e.g., using tubular and/or autoclave reactors) are also contemplated and available from ExxonMobil Chemical Company, Houston, Tex.

### Propylene-Based Polymers

In several classes of embodiments of the invention, propylene-based polymers or polypropylene polymers may be used. The two terms may be used interchangeably unless otherwise stated and distinguished. Propylene-based polymers include homopolymers or copolymers comprising from 60 wt % or 70 wt % or 80 wt % or 85 wt % or 90 wt % or 95 wt % or 98 wt % or 99 wt % to 100 wt % propylene-derived units; comprising within the range of from 0 wt % or 1 wt % or 5 wt % to 10 wt % or 15 wt % or 20 wt % or 30 wt % or 40 wt % C2 and/or C4 to C10 α-olefin derived units; and can be made by any desirable process using any desirable catalyst as is known in the art, such as a Ziegler-Natta catalyst, a metallocene catalyst, or other single-site catalyst, using solution, slurry, high pressure, or gas phase processes. Certain polypropylenes have within the range from 0.2 wt % or 0.5 wt % to 1 wt % or 2 wt % or 5 wt % ethylene-derived units. Propylene-based copolymers are useful polymers in certain embodiments, especially copolymers of propylene with ethylene and/or butene, and comprise propylene-derived units within the range of from 70 wt % or 80 wt % to 95 wt % or 98 wt % by weight of the polypropylene. In any case, useful polypropylenes have a DSC melting point (ASTM D3418) of at least 130° C. or 140° C. or 150° C. or 160° C. or 165° C., or within a range of from 130° C. or 135° C. or 140° C. to 150° C. or 160° C. or 170° C. A “highly crystalline” polypropylene is preferred in certain embodiments of the invention, and is typically isotactic and comprises 100 wt % propylene-derived units (propylene homopolymer) and has a relatively high melting point of from greater than (greater than or equal to) 130° C. or 140° C. or 145° C. or 150° C. or 155° C. or 160° C. or 165° C.

The term “crystalline,” as used herein, characterizes those polymers which possess high degrees of inter- and intra-molecular order. In some embodiments, the polypropylene has a heat of fusion (Hf) greater than 60 J/g or 70 J/g or 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer. Also, the polypropylene polymers may have a glass transition temperature (ISO 11357-1, Tg) preferably between −20° C. or −10° C. or 0° C. to 10° C. or 20° C. or 40° C. or 50° C. Preferably, the polypropylenes have a Vicat softening temperature (ISO 306, or ASTM D 1525) of greater than 120° C. or 110° C. or 105° C. or 100° C., or within a range of from 100° C. or 105° C. to 110° C. or 120° C. or 140° C. or 150° C., or a particular range of from 110° C. or 120° C. to 150° C.

The polypropylene polymers may have a melt flow rate (“MFR”, 230° C., 2.16 kg, ASTM D1238) within the range from 10, or 18 g/10 min to 40, or 50, or 60, or 80, g/10 min. Also, the polypropylene polymers may have a molecular weight distribution (determined by GPC) of from 1.5 or 2.0 or 2.5 to 3.0 or 3.5 or 4.0 or 5.0 or 6.0 or 8.0 in certain embodiments.

Suitable grades of polypropylene that are useful in the compositions described herein include those made by ExxonMobil, LyondellBasell, Total, Borealis, Japan Polypropylene, Mitsui, and other sources. A description of semi-crystalline polypropylene polymers and reactor copolymers can be found in “Polypropylene Handbook”, (E. P. Moore Editor, Carl Hanser Verlag, 1996).

In several classes of embodiments of the invention, the propylene-based polymers may also include the so-called impact copolymer (ICP). Such ICPs are themselves two phase systems, however in the present heterophase blends, each of the two individual phases of the ICP may generally blend with the respective phase of the blend, i.e., crystalline and/or amorphous. As indicated, an ICP can be in the polypropylene component as part—or all—of the polypropylene component, used in combinations with the other components of the hetero phase composition. The polypropylene homopolymer portion of the ICPs have melt flow rates (MFR) (determined by the ASTM D1238 technique, condition L) in the range of from 15 to 200, or at least 15 and/or less than 120 dg/min. Exemplary α-olefins for the rubber portion of the ICP, may be selected from one or more of ethylene, propylene; and C4 to C20 α-olefins such as 1-butene; 1-pentene, 2-methyl-1-pentene, 3-methyl-1-butene; 1-hexene, 3-methyl-1-pentene, 4-methyl-1-pentene; 3,3-dimethyl-1-butene; 1-heptene; 1-hexene; methyl-1-hexene; dimethyl-1-pentene; trimethyl-1-butene; ethyl-1-pentene; 1-octene; methyl-1-pentene; dimethyl-1-hexene; trimethyl-1-pentene; ethylhexene-1; methylethyl-1-pentene; diethyl-1-butene; 1-propyl-1-pentene; 1-decene; methyl-1-nonene; 1-nonene; dimethyl-1-octene; trimethyl-1-heptene; 1-ethyl-1-octene; methylethyl-1-butene; diethyl-1-hexene; 1-dodecene, and 1-hexadodecene.

Suitably, if ethylene is the α-olefin in the rubber phase of the ICP, it may be present in the range of from 25 to 70 wt %, or at least 30 and/or less than 65 wt % based on the weight of the rubber phase. The rubber phase may be present in the ICP in the range of from 4 to 20 wt %, or at least 6 or 10 wt % and/or less than 18 wt %, all based on the total weight of the ICP. The MFR of the ICP may be in the range of from 15 to 60, or may be at least 20 and/or less than 50 or less than 40 dg/min.

The ICP may be a physical blend of iPP and EP rubber, or a so-called reactor blend. In any case, the ICP is a blend of polypropylene and one or more elastomeric polymers of the ethylene α-olefin type, generally ethylene propylene elastomeric polymers. The ICP useful in embodiments of our invention may be prepared by conventional polymerization techniques such as a two-step gas phase process using Ziegler-Natta catalysis. For example, see U.S. Pat. No. 4,379,759 which is fully incorporated by reference. The ICPs of embodiments of our invention are preferably produced in reactors operated in series, and the second polymerization, may be carried out in the gas phase. The first polymerization, may be a liquid slurry or solution polymerization process. Metallocene catalyst systems may be used to produce the ICP compositions useful in embodiments of our invention. Current particularly suitable metallocenes are those in the generic class of bridged, substituted bis(cyclopentadienyl) metallocenes, specifically bridged, substituted bis(indenyl) metallocenes known to produce high molecular weight, high melting, highly isotactic propylene polymers. Generally speaking, those of the generic class disclosed in U.S. Pat. No. 5,770,753 (fully incorporated herein by reference) should be suitable.

In yet another class of embodiments of the invention, the propylene-based polymer may also include a Propylene Based Elastomer (“PBE”), which comprises propylene and from about 5 to about 25 wt % of one or more comonomers selected from ethylene and/or C₄-C₁₂ α-olefins. In one or more embodiments, the α-olefin comonomer units may be derived from ethylene, butene, pentene, hexene, 4-methyl-1-pentene, octene, or decene. The embodiments described below are discussed with reference to ethylene as the α-olefin comonomer, but the embodiments are equally applicable to other copolymers with other α-olefin comonomers. In this regard, the copolymers may simply be referred to as propylene-based polymers with reference to ethylene as the α-olefin.

In one or more embodiments, the PBE may include at least about 5 wt %, at least about 6 wt %, at least about 7 wt %, or at least about 8 wt %, or at least about 9 wt %, or at least about 10 wt %, or at least about 12 wt % ethylene-derived units. In those or other embodiments, the PBE may include up to about 30 wt %, or up to about 25 wt %, or up to about 22 wt %, or up to about 20 wt %, or up to about 19 wt %, or up to about 18 wt %, or up to about 17 wt % ethylene-derived units, where the percentage by weight is based upon the total weight of the propylene-derived and α-olefin derived units. Stated another way, the PBE may include at least about 70 wt %, or at least about 75 wt %, or at least about 80 wt %, or at least about 81 wt % propylene-derived units, or at least about 82 wt % propylene-derived units, or at least about 83 wt % propylene-derived units; and in these or other embodiments, the PBE may include up to about 95 wt %, or up to about 94 wt %, or up to about 93 wt %, or up to about 92 wt %, or up to about 90 wt %, or up to about 88 wt % propylene-derived units, where the percentage by weight is based upon the total weight of the propylene-derived and α-olefin derived units. In certain embodiments, the PBE may comprise from about 5 to about 25 wt % ethylene-derived units, or from about 9 to about 18 wt % ethylene-derived units.

The PBEs of one or more embodiments are characterized by a melting point (Tm), which can be determined by differential scanning calorimetry (DSC). For purposes related to the description of the PBE, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In one or more embodiments, the Tm of the PBE (as determined by DSC) is less than about 115° C., or less than about 110° C., or less than about 100° C., or less than about 95° C., or less than about 90° C.

In one or more embodiments, the PBE may be characterized by its heat of fusion (Hf), as determined by DSC. In one or more embodiments, the PBE may have an Hf that is at least about 0.5 J/g, or at least about 1.0 J/g, or at least about 1.5 J/g, or at least about 3.0 J/g, or at least about 4.0 J/g, or at least about 5.0 J/g, or at least about 6.0 J/g, or at least about 7.0 J/g. In these or other embodiments, the PBE may be characterized by an Hf of less than about 75 J/g, or less than about 70 J/g, or less than about 60 J/g, or less than about 50 J/g, or less than about 45 J/g, or less than about 40 J/g, or less than about 35 J/g, or less than about 30 J/g.

For purposes for describing the PBE, the DSC procedure for determining Tm and Hf include the following. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a DSC (Perkin Elmer Pyris One Thermal Analysis System) and cooled to about −50° C. to about −70° C. The sample is heated at 10° C./min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. It is measured in Joules and is a measure of the Hf of the polymer.

The PBE may have a triad tacticity of three propylene units, as measured by 13C NMR, of 75% or greater, 80% or greater, 85% or greater, 90% or greater, 92% or greater, 95% or greater, or 97% or greater. In one or more embodiments, the triad tacticity may range from about 75 to about 99%, or from about 80 to about 99%, or from about 85 to about 99%, or from about 90 to about 99%, or from about 90 to about 97%, or from about 80 to about 97%. Triad tacticity is determined by the methods described in U.S. Pat. No. 7,232,871.

The PBE may have a tacticity index ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios of greater than 50.

In one or more embodiments, the PBE may have a % crystallinity of from about 0.5% to about 40%, or from about 1% to about 30%, or from about 5% to about 25%, determined according to DSC procedures. Crystallinity may be determined by dividing the Hf of a sample by the Hf of a 100% crystalline polymer, which is assumed to be 189 joules/gram for isotactic polypropylene or 350 joules/gram for polyethylene.

In one or more embodiments, the PBE may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature, as measured per the ASTM D-792.

In one or more embodiments, the PBE can have a melt index (MI) (ASTM D-1238, 2.16 kg @ 190° C.), of less than or equal to about 100 g/10 min., or less than or equal to about 50 g/10 min., or less than or equal to about 25 g/10 min., or less than or equal to about 10 g/10 min., or less than or equal to about 9.0 g/10 min., or less than or equal to about 8.0 g/10 min., or less than or equal to about 7.0 g/10 min.

In one or more embodiments, the PBE may have a melt flow rate (MFR), as measured according to ASTM D-1238 (2.16 kg weight @ 230° C.), greater than about 1 g/10 min., or greater than about 2 g/10 min., or greater than about 5 g/10 min., or greater than about 8 g/10 min., or greater than about 10 g/10 min. In the same or other embodiments, the PBE may have an MFR less than about 500 g/10 min., or less than about 400 g/10 min., or less than about 300 g/10 min., or less than about 200 g/10 min., or less than about 100 g/10 min., or less than about 75 g/10 min., or less than about 50 g/10 min. In certain embodiments, the PBE may have an MFR from about 1 to about 100 g/10 min., or from about 2 to about 75 g/10 min., or from about 5 to about 50 g/10 min.

Suitable commercially available propylene-based polymers include Vistamaxx™ Performance Polymers from ExxonMobil Chemical Company and Versify™ Polymers from The Dow Chemical Company.

### Polymer Blends

One or more of the polyolefin polymers described above may be used with one or more additives as described below, optionally, in combination with other polymers known in the art, for example, in a composition comprising a blend.

For example, in a class of embodiments of the invention, a composition may comprise from 1 wt % to 99.5 wt % of the polyolefin polymers described above, based upon the total weight of the composition, and if the composition comprises two or more polymers, the first polymer may be from 1 wt % to 99 wt % and the second polymer may be from 99 wt % to 1 wt %, based upon the total weight of the composition. Alternative embodiments include from 50 wt % to 90 wt %, from 60 wt % to 80 wt %, or from 60 wt % to 70 wt %, of the polyolefin polymer, based upon the total weight of the composition, with the balance of constituents comprising optional additional polymers and the additives described below.

### Additives

The polymers and compositions described above may be used in combination with the following additives and other components.

### First Antioxidant

The first antioxidant comprises one or more antioxidants. They include, but are not limited to, hindered phenols, for example, octadecyl-3-(3,5-di-tert.butyl-4-hydroxyphenyl)-propionate (CAS 002082-79-3) commercially available as IRGANOX™ 1076, pentaerythritol tetrakis(3-(3,5-di-tert-butyl-4-hydroxyphenyl)propionate) (CAS 6683-19-8) commercially available as IRGANOX™ 1010; and combinations thereof.

They may be combined with one or more polymers in range from 100 to 4000 parts by weight of the first antioxidant, based on one million parts of the polymer or polymer composition; alternatively, from 250 to 3000 parts by weight of the first antioxidant, based on one million parts of the polymer or polymer composition, alternatively, from 500 to 2500 parts by weight of the first antioxidant, based on one million parts of the polymer or polymer composition, alternatively, from 750 to 2500 parts by weight of the first antioxidant, based on one million parts of the polymer or polymer composition, alternatively, from 750 to 2000 parts by weight of the first antioxidant, based on one million parts of the polymer or polymer composition, and alternatively, from 1000 to 2000 parts by weight of the first antioxidant, based on one million parts of the polymer or polymer composition.

### Second Antioxidant

The second antioxidant comprises one or more antioxidants. They include, but are not limited to, liquid phosphites, such as C₂-C₇, preferably C₂-C₄, alkyl aryl phosphites mixed structures. Non-limiting examples include mono-amylphenyl phosphites, di-amylphenyl phosphites, dimethylpropyl phosphites, 2-methylbutanyl phosphites, and combinations thereof. In several embodiments of the invention, the second antioxidant may also be represented by the formula [4-(2-methylbutan-2-yl)phenyl]ₓ[2,4-bis(2-methylbutan-2-yl)phenyl]₃₋ₓ phosphate, wherein x=0, 1, 2, 3, or combinations thereof.

Additional exemplary examples include the following:

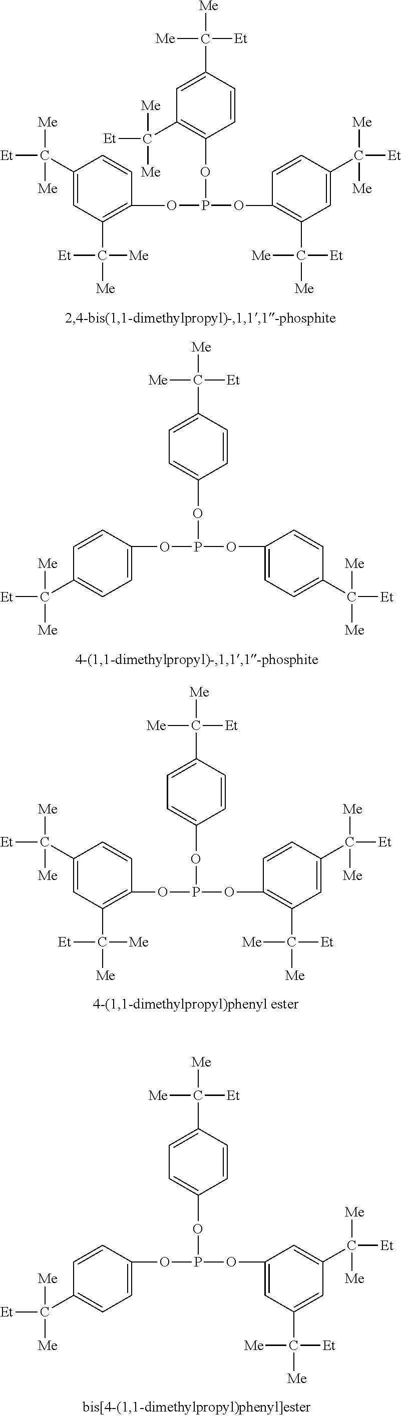 [SMILES: CCC(C)(C)c1ccc(OP(Oc2ccc(C(C)(C)CC)cc2C(C)(C)CC)Oc2ccc(C(C)(C)CC)cc2C(C)(C)CC)c(C(C)(C)CC)c1 ; CCC(C)(C)c1ccc(OP(Oc2ccc(C(C)(C)CC)cc2)Oc2ccc(C(C)(C)CC)cc2)cc1 ; CCC(C)(C)c1ccc(OP(Oc2ccc(C(C)(C)CC)cc2C(C)(C)CC)Oc2ccc(C(C)(C)CC)cc2C(C)(C)CC)cc1 ; CCC(C)(C)c1ccc(OP(Oc2ccc(C(C)(C)CC)cc2)Oc2cc(C(C)(C)CC)cc(C(C)(C)CC)c2)cc1]

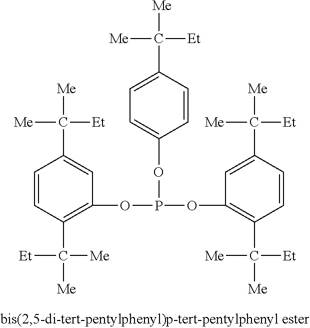 [SMILES: CCC(C)(C)c1ccc(OP(Oc2cc(C(C)(C)CC)ccc2C(C)(C)CC)Oc2cc(C(C)(C)CC)ccc2C(C)(C)CC)cc1]

An example of a commercially available liquid phosphite is sold under the tradename WESTON™ 705 (Addivant, Danbury, Conn.).

Such antioxidants and their use with polyolefin polymers have been described in U.S. Patent Application Nos. 20050113494, 20070021537, 2009/0326112, 2013/0190434, 2013/225738, 2014/0045981 and U.S. Pat. Nos. 5,254,709, 6,444,836, 7,888,414, 7,947,769, 8,008,383, 8,048,946, 8,188,170, and 8,258,214.

The second antioxidant may be combined with one or more polymers in range from 100 to 4000 parts by weight of the second antioxidant, based on one million parts of the polymer or polymer composition; alternatively, from 250 to 3000 parts by weight of the second antioxidant, based on one million parts of the polymer or polymer composition, alternatively, from 300 to 2000 parts by weight of the second antioxidant, based on one million parts of the polymer or polymer composition, alternatively, from 400 to 1450 parts by weight of the second antioxidant, based on one million parts of the polymer or polymer composition, alternatively, from 425 to 1650 parts by weight of the second antioxidant, based on one million parts of the polymer or polymer composition, and alternatively, from 1 to 450 parts by weight of the second antioxidant, based on one million parts of the polymer or polymer composition.

The following table provides additional non-limiting examples of how the second antioxidant may be used with specific polymers.

| Polyolefin | Typical | minimum | maximum |
|---|---|---|---|
| Metallocene PE | 1000-1500 ppm | 500 ppm | 2000 ppm |
| Ziegler-Natta LLDPE | 1000-1700 ppm | 750 ppm | 2000 ppm |
| HDPE | 1250-1450 ppm | 500 ppm | 2000 ppm |
| VLDPE (Exact ™ | 400-1700 ppm | 300 ppm | 2000 ppm |
| Polymer, | | | |
| ExxonMobil | | | |
| Chemical Company) | | | |
| Polypropylene | 400-1500 ppm | 300 ppm | 2000 ppm |

The polymers and/or compositions comprising the first antioxidant and/or the second antioxidant described above may be used in combination with the following neutralizing agents, additional additives and other components.

### Neutralizing Agents

The one or more neutralizing agents (also called catalyst deactivators) include, but are not limited to, calcium stearate, zinc stearate, calcium oxide, synthetic hydrotalcite, such as DHT4A, and combinations thereof.

### Additional Additives and Other Components

Additional additives and other components include, but are limited to, fillers (especially, silica, glass fibers, talc, etc.) colorants or dyes, pigments, color enhancers, whitening agents, cavitation agents, anti-slip agents, lubricants, plasticizers, processing aids, antistatic agents, antifogging agents, nucleating agents, stabilizers, mold release agents, and other antioxidants (for example, hindered amines and phosphates). Nucleating agents include, for example, sodium benzoate and talc. Slip agents include, for example, oleamide and erucamide.

### End-Use Applications

Any of the foregoing polymers and compositions in combination with the additives described above may be used in a variety of end-use applications. Such end uses may be produced by methods known in the art. End uses include polymer products and products having specific end-uses. Exemplary end uses are films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

### Films

Films include monolayer or multilayer films. Films include those film structures and film applications known to those skilled in the art. Specific end use films include, for example, cast films, stretch films, stretch/cast films, stretch cling films, stretch handwrap films, machine stretch wrap, shrink films, shrink wrap films, green house films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In one embodiment, multilayer films or multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

To facilitate discussion of different film structures, the following notation is used herein. Each layer of a film is denoted “A” or “B”. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer disposed between two outer layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film, for purposes described herein. The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20.

The thickness of each layer of the film, and of the overall film, is not particularly limited, but is determined according to the desired properties of the film. Typical film layers have a thickness of from about 1 to about 1000 μm, more typically from about 5 to about 100 μm, and typical films have an overall thickness of from about 10 to about 100 μm.

In some embodiments, and using the nomenclature described above, the present invention provides for multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″″; and similar structures for films having six, seven, eight, nine, twenty-four, forty-eight, sixty-four, one hundred, or any other number of layers. It should be appreciated that films having still more layers.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films may also be used as coatings for substrates such as paper, metal, glass, plastic and other materials capable of accepting a coating.

The films can further be embossed, or produced or processed according to other known film processes. The films can be tailored to specific applications by adjusting the thickness, materials and order of the various layers, as well as the additives in or modifiers applied to each layer.

### Stretch Films

The polyolefin polymers and additives as described above may be utilized to prepare stretch films. Stretch films are widely used in a variety of bundling and packaging applications. The term “stretch film” indicates films capable of stretching and applying a bundling force, and includes films stretched at the time of application as well as “pre-stretched” films, i.e., films which are provided in a pre-stretched form for use without additional stretching. Stretch films can be monolayer films or multilayer films, and can include conventional additives, such as cling-enhancing additives such as tackifiers, and non-cling or slip additives, to tailor the slip/cling properties of the film.

### Shrink Films

The polyolefin polymers and additives as described above may be utilized to prepare shrink films. Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction or in both longitudinal and transverse directions. Conventional shrink films are described, for example, in WO 2004/022646, which is herein incorporated by reference in its entirety.

Industrial shrink films are commonly used for bundling articles on pallets. Typical industrial shrink films are formed in a single bubble blown extrusion process to a thickness of about 80 to 200 μm, and provide shrinkage in two directions, typically at a machine direction (MD) to transverse direction (TD) ratio of about 60:40.

Retail films are commonly used for packaging and/or bundling articles for consumer use, such as, for example, in supermarket goods. Such films are typically formed in a single bubble blown extrusion process to a thickness of about 35 to 80, μm, with a typical MD:TD shrink ratio of about 80:20.

One use for films made from the polymers and/or blends described herein is in “shrink-on-shrink” applications. “Shrink-on-shrink,” as used herein, refers to the process of applying an outer shrink wrap layer around one or more items that have already been individually shrink wrapped (herein, the “inner layer” of wrapping). In these processes, it is desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer. Some films described herein have been observed to have a sharp shrinking point when subjected to heat from a heat gun at a high heat setting, which indicates that they may be especially suited for use as the inner layer in a variety of shrink-on-shrink applications.

### Greenhouse Films

The polyolefin polymers and additives as described above may be utilized to prepare stretch to prepare greenhouse films. Greenhouse films are generally heat retention films that, depending on climate requirements, retain different amounts of heat. Less demanding heat retention films are used in warmer regions or for spring time applications. More demanding heat retention films are used in the winter months and in colder regions.

### Bags

Bags include those bag structures and bag applications known to those skilled in the art. Exemplary bags include shipping sacks, trash bags and liners, industrial liners, produce bags, and heavy duty bags.

### Packaging

Packaging includes those packaging structures and packaging applications known to those skilled in the art. Exemplary packaging includes flexible packaging, food packaging, e.g., fresh cut produce packaging, frozen food packaging, bundling, packaging and unitizing a variety of products. Applications for such packaging include various foodstuffs, rolls of carpet, liquid containers, and various like goods normally containerized and/or palletized for shipping, storage, and/or display.

### Blow Molded Articles

The polyolefin polymers or compositions made therefrom including the additives described above may also be used in blow molding processes and applications. Such processes are well known in the art, and involve a process of inflating a hot, hollow thermoplastic preform (or parison) inside a closed mold. In this manner, the shape of the parison conforms to that of the mold cavity, enabling the production of a wide variety of hollow parts and containers.

In a typical blow molding process, a parison is formed between mold halves and the mold is closed around the parison, sealing one end of the parison and closing the parison around a mandrel at the other end. Air is then blown through the mandrel (or through a needle) to inflate the parison inside the mold. The mold is then cooled and the part formed inside the mold is solidified. Finally, the mold is opened and the molded part is ejected. The process lends itself to any design having a hollow shape, including but not limited to bottles, tanks, toys, household goods, automobile parts, and other hollow containers and/or parts.

Blow molding processes may include extrusion and/or injection blow molding. Extrusion blow molding is typically suited for the formation of items having a comparatively heavy weight, such as greater than about 12 ounces, including but not limited to food, laundry, or waste containers. Injection blow molding is typically used to achieve accurate and uniform wall thickness, high quality neck finish, and to process polymers that cannot be extruded. Typical injection blow molding applications include, but are not limited to, pharmaceutical, cosmetic, and single serving containers, typically weighing less than 12 ounces.

### Injection Molded Articles

The polyolefin polymers or compositions made therefrom including the additives described above may also be used in injection molded applications. Injection molding is a process commonly known in the art, and is a process that usually occurs in a cyclical fashion. Cycle times generally range from 10 to 100 seconds and are controlled by the cooling time of the polymer or polymer blend used.

In a typical injection molding cycle, polymer pellets or powder are fed from a hopper and melted in a reciprocating screw type injection molding machine. The screw in the machine rotates forward, filling a mold with melt and holding the melt under high pressure. As the melt cools in the mold and contracts, the machine adds more melt to the mold to compensate. Once the mold is filled, it is isolated from the injection unit and the melt cools and solidifies. The solidified part is ejected from the mold and the mold is then closed to prepare for the next injection of melt from the injection unit.

Injection molding processes offer high production rates, good repeatability, minimum scrap losses, and little to no need for finishing of parts. Injection molding is suitable for a wide variety of applications, including containers, household goods, automobile components, electronic parts, and many other solid articles.

### Extrusion Coating

The polyolefin polymers or compositions made therefrom including the additives described above may be used in extrusion coating processes and applications. Extrusion coating is a plastic fabrication process in which molten polymer is extruded and applied onto a non-plastic support or substrate, such as paper or aluminum in order to obtain a multi-material complex structure. This complex structure typically combines toughness, sealing and resistance properties of the polymer formulation with barrier, stiffness or aesthetics attributes of the non-polymer substrate. In this process, the substrate is typically fed from a roll into a molten polymer as the polymer is extruded from a slot die, which is similar to a cast film process. The resultant structure is cooled, typically with a chill roll or rolls, and would into finished rolls.

Extrusion coating materials are typically used in food and non-food packaging, pharmaceutical packaging, and manufacturing of goods for the construction (insulation elements) and photographic industries (paper).

### Foamed Articles

In some embodiments, the polyolefin polymers or compositions made therefrom including the additives described above may be used in foamed applications. In an extrusion foaming process, a blowing agent, such as, for example, carbon dioxide, nitrogen, or a compound that decomposes to form carbon dioxide or nitrogen, is injected into a polymer melt by means of a metering unit. The blowing agent is then dissolved in the polymer in an extruder, and pressure is maintained throughout the extruder. A rapid pressure drop rate upon exiting the extruder creates a foamed polymer having a homogenous cell structure. The resulting foamed product is typically light, strong, and suitable for use in a wide range of applications in industries such as packaging, automotive, aerospace, transportation, electric and electronics, and manufacturing.

### Wire and Cable Applications

Also provided are electrical articles and devices including one or more layers formed of or comprising the polyolefin polymers or compositions made therefrom including the additives described above. Such devices include, for example, electronic cables, computer and computer-related equipment, marine cables, power cables, telecommunications cables or data transmission cables, and combined power/telecommunications cables.

Electrical devices described herein can be formed by methods well known in the art, such as by one or more extrusion coating steps in a reactor/extruder equipped with a cable die. Such cable extrusion apparatus and processes are well known. In a typical extrusion method, an optionally heated conducting core is pulled through a heated extrusion die, typically a cross-head die, in which a layer of melted polymer composition is applied. Multiple layers can be applied by consecutive extrusion steps in which additional layers are added, or, with the proper type of die, multiple layers can be added simultaneously. The cable can be placed in a moisture curing environment, or allowed to cure under ambient conditions.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Test Method

The first step to measure low molecular weight materials coming from the antioxidants is the extraction of such components by a boiling step in hexane and chloroform (1/2 ratio) for at least 8 hours. After cooling, the supernatant may be analyzed by HPLC for nonylphenol with a UV detector versus external standards for quantification. For DTAP and PTAP, the low molecular material in the case of Weston 705™ Additive a GC-MS method is used, also versus external standards for quantification.

### Example 1

Exceed™ 3518CB, a metallocene PE grade, designed for cast film applications was made with the current stabilization process, based on Irganox™ 1076 and Weston™ 399 Additives (TNPP) in a commercial production environment. It was also made with an equivalent formulation with Weston™ 705 Additives replacing TNPP. The TNPP stabilized lots had between 33 and 73 ppm of free nonylphenols. The Weston 705 stabilized lots had between 21 and 30 ppm of free DTAP+PTAP.

### Example 2

Enable™ 20-LOCH, a metallocene PE grade, designed for blown film applications was made with the current stabilization process, based on Irganox™ 1076 and Weston™ 399 Additives (TNPP) in a commercial production environment. It was also made with an equivalent formulation with Weston™ 705 Additives replacing TNPP. The TNPP stabilized lots had between 38 and 66 ppm of free nonylphenols. The Weston 705 stabilized lots had 30 ppm of free DTAP+PTAP.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A composition comprising:
a) at least one polyolefin polymer,
b) from 100 to 4000 parts by weight of a first antioxidant, and
c) from 1 to 450 parts by weight of a second antioxidant, based on one million parts of the polyolefin polymer.

2. The composition of claim 1, wherein the first antioxidant is a hindered phenol.

3. The composition of claim 2, wherein the hindered phenol is octadecyl-3-(3,5-di-tert.butyl-4-hydroxyphenyl)-propionate, pentaerythritol tetrakis(3-(3,5-di-tert-butyl-4-hydroxyphenyl)propionate), or a combination thereof.

4. The composition of claim 1, wherein the second antioxidant comprises a mixture of C₂-C₄ alkyl aryl phosphites.

5. The composition of claim 1, wherein the second antioxidant is represented by the formula [4-(2-methylbutan-2-yl)phenyl]ₓ [2,4-bis(2-methylbutan-2-yl)phenyl]₃₋ₓ phosphate, wherein x=0, 1, 2, 3, or combinations thereof.

6. The composition of claim 1, wherein the second antioxidant comprises mono-amylphenyl phosphites, di-amylphenyl phosphites, dimethylpropyl phosphites, 2-methylbutanyl phosphites, or combinations thereof.

7. The composition of claim 1, wherein the composition comprises from 750 to 2500 parts by weight of the first antioxidant, based on one million parts of the polyolefin polymer.

8. The composition of claim 1, wherein the composition comprises from 1000 to 2000 parts by weight of the first antioxidant, based on one million parts of the polyolefin polymer.

9. The composition of claim 1, wherein the composition further comprises one or more of neutralizing agents, fillers, colorants, dyes, pigments, color enhancers, whitening agents, cavitation agents, anti-slip agents, lubricants, plasticizers, processing aids, antistatic agents, antifogging agents, nucleating agents, stabilizers, mold release agents, or other antioxidants.

10. The composition of claim 1, wherein the polyolefin polymer has a density from 0.905 g/cm³ to 0.945 g/cm³.

11. The composition of claim 1, wherein the polyolefin polymer has a density from 0.905 g/cm³ to 0.930 g/cm³.

12. The composition of claim 1, wherein the polyolefin polymer has a density from 0.850 g/cm³ to 0.920 g/cm³.

13. The composition of claim 1, wherein the polyolefin polymer has a melt index (I₂) from 0.10 g/10 min to 3.0 g/10 min.

14. The composition of claim 1, wherein the polyolefin polymer has a melt index (I₂) from 0.5 g/10 min to 2.0 g/10 min.

15. The composition of claim 1, wherein the polyolefin polymer has a melt index ratio (I₂₁/I₂) from 30 to 55.

16. The composition of claim 1, wherein the polyolefin polymer has a melt index ratio (I₂₁/I₂) from 15 to 20.

17. The composition of claim 1, wherein the polyolefin polymer is one or more ethylene-based polymers.

18. The composition of claim 17, wherein at least one of the one or more ethylene-based polymers is a metallocene polyethylene polymer and made in a gas phase polymerization process.

19. The composition of claim 1, wherein the polyolefin polymer is one or more propylene-based polymers.

20. The composition of claim 19, where at least one of the one or more propylene-based polymers has a heat of fusion as determined by DSC of less than 75 J/g, a melting point of less than 115° C., and/or a triad tacticity of three propylene units, as measured by 13C NMR, of 75% or greater.

21. An article made from the composition of claim 1, wherein the article is selected from the group consisting of a film, a bag, packaging, a blow molded article, an injection molded article, a coating, a foamed article, a wire, and a cable.
